(19) United States
(12) Patent Application Publication
(10) Pub. No.: US 2013/0134703 A1
(43) Pub. Date: May 30, 2013

(54) ARCHIMEDES SCREW ASSEMBLY

(71) Applicant: Robert Pennell Williams, Ripon (GB)

(72) Inventor: Robert Pennell Williams, Ripon (GB)

(73) Assignee: THE ARCHIMEDES SCREW COMPANY LIMITED, Ripon, North Yorkshire (GB)

(21) Appl. No.: 13/640,908

(22) PCT Filed: Apr. 14, 2011
(86) PCT No.: PCT/GB2011/000574

§ 371 Date: Jan. 9, 2013

(30) Foreign Application Priority Data
Apr. 17, 2010 (GB) 1006445.9

(51) Int. Cl. F16L 39/00

(52) U.S. Cl. CPC F16L 39/00
USPC 285/124.1

(57) ABSTRACT

An Archimedes screw assembly comprising a plurality of helically curved tubular components (10) mounted together end to end, and for instance in three sets, to define a three start helix.

This invention concerns an Archimedes screw assembly, and also a method of forming an Archimedes screw assembly.

Archimedes screw assemblies can be used in generators or pumps. Conventionally such screws are formed from a multistart helix around a central spine. The helix can then be rigidly mounted within a rotatable tube, or may be rotatably mounted in a trough or fixed tube. Manufacturing a helical screw in this way can be relatively complex and expensive.

According to the present invention there is provided an Archimedes screw assembly, the assembly including a plurality of tubular components which curve and extend longitudinally, and are mountable together end to end to define a tubular helix.

The components may each comprise a complete helix, or may define a helical curve through an angle about the assembly axis of up to 380°, particularly between 90° and 270°, more particularly between 130 and 230°, more specifically between 160 and 200°, and may curve through substantially 180°.

A plurality of sets of components may be mountable together about a common axis to define a multistart tubular helix. Three sets may be provided to form a three start helix.

The components may be configured such that the sets are intertwined together so as to be substantially self supporting.

The components may have a generally rectangular cross section, and may have a generally square cross section. Alternatively the components may have a flattened oval or circular cross section.

Mounting formations may be provided on the ends of the components, and the mounting formations may provide a push fit. The mounting formations may include respective male and female members. Sealing gaskets may be provided locatable between adjacent components.

The components may be made of plastics material and may be made of polyethylene. The components may be made by rotational moulding. Alternatively the components may be made of a composite material or may be made of metal.

In one embodiment each component is made of a number of parts mounted together.

The interconnected components may be mounted in a tubular housing, or around a central structural core, which housing or core may be made of metal.

The invention also provides a method of forming an Archimedes screw assembly, the method including mounting together a plurality of components according to any of the preceding nine paragraphs.

The components may be mounted together by any of friction, welding, bolting, screw flanges or adhesive.

The invention also provides an Archimedes screw assembly made by a method according to either of the preceding paragraphs.

The invention yet further provides a tubular component according to any of said preceding nine paragraphs.

An embodiment of the present invention will now be described by way of example only and with reference to the accompanying drawings, in which:

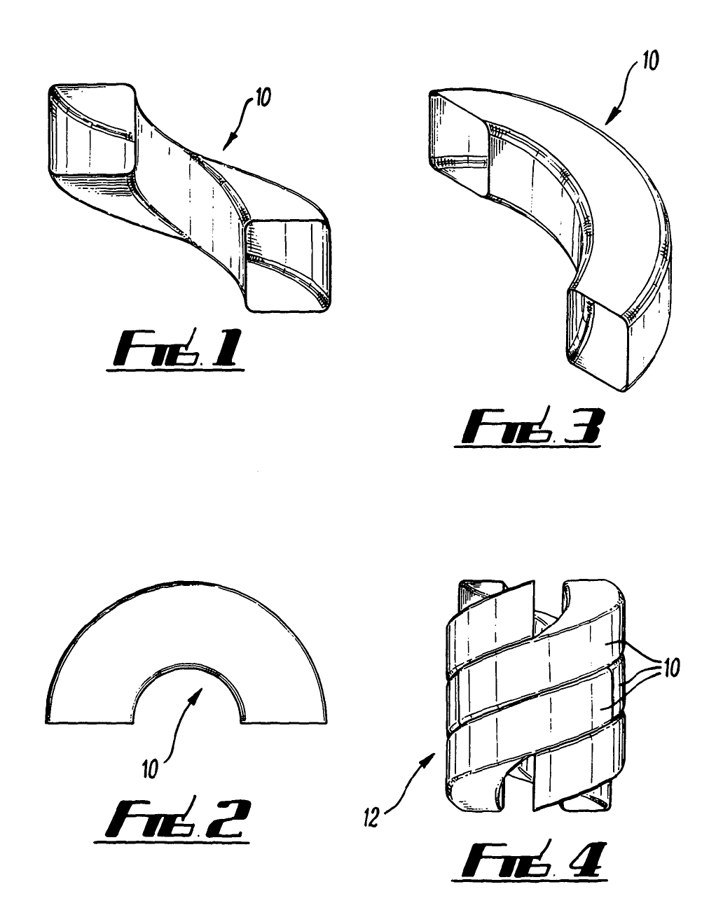

FIG. 1 is a diagrammatic side view of a component according to the invention;

FIG. 2 is a plan view of the component of FIG. 1;

FIG. 3 is a diagrammatic perspective view of the component of FIG. 1;

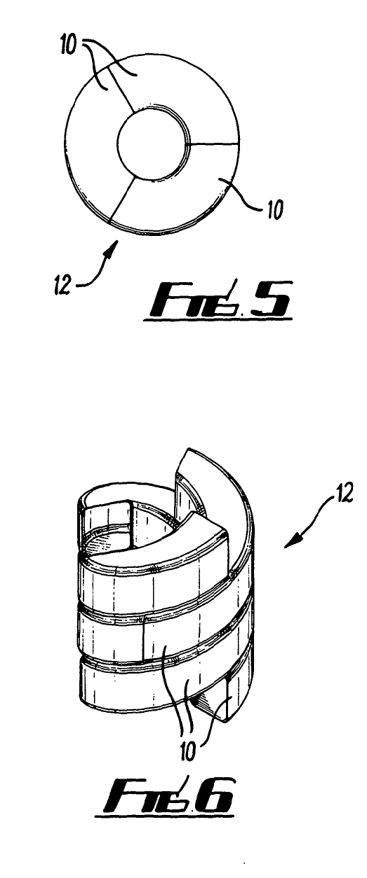

FIG. 4 is a diagrammatic side view of an Archimedes screw assembly made from a plurality of components according to FIG. 1;

FIG. 5 is a plan view of the assembly of FIG. 4; and

FIG. 6 is a perspective view from above of the assembly of FIG. 4.

FIGS. 1 to 3 show a tubular component 10 inter engageable with similar such components 10 to form a helix configuration 12 as shown in FIGS. 4 to 6. Each component 10 is of generally rectangular cross section with a radial extent which is slightly less than the axial extent, and the rectangular cross section has rounded corners.

Each component 10 is curved and extends longitudinally, i.e. is helical. Each component extends through an angle of 180°, with a pitch of substantially three times the axial extent of the component cross section.

The components 10 can be mounted together end to end, to define a helix, and three sets of components can be joined end to end and intertwined as shown in FIGS. 4 to 6 to provide a three start tubular helix. As can be seen, because of the pitch of the components 10 such a configuration is essentially self supporting. Connecting formations (not shown) are provided on the ends of the components 10 in the form of cooperating male and female members and provide a push fit therebetween. Gaskets (not shown) may also be provided between adjacent components 10.

As shown in FIGS. 4 to 6 the components 10 can be fitted together to provide a multistart tubular helix, and in practice a longer helix will probably be produced than that shown diagrammatically in the drawings. Such a helix can be used in an Archimedes screw generator or pump. The screw may be mounted in a tubular housing, which housing is rotatably mounted. The housing may be made for instance of metal. In this example each component 10 is formed from rotational moulding of polyethylene.

There is thus provided a tubular component which can readily be formed into a Archimedes screw assembly which provides a number of advantages over existing configurations. Each component is significantly easier to manufacture than a complete multistart helix, whilst the components can readily be mounted together. These components can be made relatively inexpensively and will provide a lightweight helix. Strength for the helix can be provided by for example by a closely fitting metal housing or by a central metal tubular core.

Various modifications may be made without departing from the scope of the invention. For instance the components could extend for a different angle and each component could define a complete helix. Arrangements could be used to produce a different number of starts of the helix, and the pitch may be chosen accordingly. The components can be mounted together differently and could for example be joined together by friction, welding, bolting, screw flanges or adhesive.

The components may be made of a different material such as a different plastics material, a composite or metal, and may be manufactured by a different technique. The components may have a different cross-sectional shape, and the cross section could for instance be in the form of a flattened oval or circle.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An Archimedes screw assembly, the assembly including a plurality of tubular components which curve and extend longitudinally, and are mountable together end to end to define a tubular helix, each of the components defining a helical curve through an angle about the assembly axis of up to 380°, with a plurality of sets of components being mountable together about a common axis to define a multistart tubular helix.

2. (canceled)

3. (canceled)

4. An assembly according to claim 1, in which the components each define a helical curve through an angle about the assembly axis of between 90° and 270°.

5. An assembly according to claim 4, in which the components each define a helical curve through an angle about the assembly axis of between 130 and 230°.

6. An assembly according to claim 5, in which the components each define a helical curve through an angle about the assembly axis of between 160 and 200°.

7. An assembly according to claim 6, in which the components each define a helical curve through an angle about the assembly axis of substantially 180°.

8. (canceled)

9. An assembly according to claim 1, in which three sets of components are provided to form a three start helix.

10. An assembly according to claim 1, in which the components are configured such that the sets are intertwined together so as to be substantially self supporting.

11. An assembly according to claim 1, in which the components have a generally rectangular cross section.

12. (canceled)

13. An assembly according to claim 1, in which the components have a flattened oval cross section.

14. An assembly according to claim 1, in which the components have a circular cross section.

15. An assembly according to claim 1, in which mounting formations are provided on the ends of the components.

16. (canceled)

17. (canceled)

18. An assembly according to claim 1, in which sealing gaskets are provided locatable between adjacent components.

19. An assembly according to claim 1, in which the components are made of plastics material.

20. (canceled)

21. An assembly according to claim 1, in which the components are made of a composite material.

22. An assembly according to claim 1, in which the components are made of metal.

23. An assembly according to claim 19, in which the components are made by rotational moulding.

24. (canceled)

25. An assembly according to claim 1, in which the interconnected components are mounted in a tubular housing.

26. (canceled)

27. An assembly according to claim 1, in which the interconnected components are mounted around a central structural core.

28. (canceled)

29. A method of forming an Archimedes screw assembly, the method including mounting together a plurality of components according to claim 1.

30. A method according to claim 29, in which the components are mounted together by any of friction, welding, bolting, screw flanges or adhesive.

31-35. (canceled)
